(19) United States
(12) Patent Application Publication
(10) Pub. No.: US 2024/0293774 A1
(43) Pub. Date: Sep. 5, 2024

(54) SYSTEM AND METHOD FOR REMOVING CARBON DIOXIDE FROM A FLOW OF GAS HAVING CARBON DIOXIDE THEREIN

(71) Applicant: Emerging Compounds Treatment Technologies, Inc., North Little Rock, AR (US)

(72) Inventors: John H. Bowie, Bellingham, WA (US); Peter Zemek, Hollis, NH (US); Steven E. Woodard, Cumberland, ME (US); Michael G. Nickelsen, Fuquay-Varina, NC (US); David Kempisty, Colorado Springs, CO (US)

(21) Appl. No.: 18/590,497

(22) Filed: Feb. 28, 2024

Related U.S. Application Data
(60) Provisional application No. 63/490,791, filed on Mar. 17, 2023.
(60) Provisional application No. 63/488,212, filed on Mar. 3, 2023.

(51) Int. Cl. B01D 53/79; B01D 53/14; B01D 53/18; B01D 53/34; B01D 53/62; B01F 23/232; B01F 25/312

(52) U.S. Cl. CPC B01D 53/79; B01D 53/1406; B01D 53/1412; B01D 53/1475; B01D 53/185; B01D 53/346; B01D 53/62; B01F 23/232; B01F 25/31233; B01F 25/31243; B01D 2257/504

(57) ABSTRACT

A system for removing carbon dioxide from a flow of gas having carbon dioxide therein is featured. The system includes a first venturi eductor and first reactor which receive the flow of gas having carbon dioxide therein and a flow of a first alkaline solution at a first predetermined pH range. The first venturi eductor and reactor mix and provide reaction time for the flow of gas having carbon dioxide therein and the flow of the first alkaline solution to induce a reaction of the carbon dioxide with the first alkaline solution to form a solution having metal bicarbonate therein. A second venturi eductor and reactor mix the flow of the partially treated gas with the flow of the second alkaline solution and provide reaction time to react a majority of the remaining carbon dioxide with the second alkaline solution to form a solution having metal carbonate therein.

### RELATED APPLICATIONS

This application claims benefit of and priority to U.S. Provisional Application Ser. No. 63/488,212 filed Mar. 3, 2023 and U.S. Provisional Application Ser. No. 63/490,791 filed Mar. 17, 2023, under 35 U.S.C. §§ 119, 120, 363, 365, and 37 C.F.R. § 1.55 and § 1.78, both of which are incorporated by reference herein.

### FIELD OF THE INVENTION

This invention relates to a system and method for removing carbon dioxide from a flow of gas having carbon dioxide therein.

### BACKGROUND OF THE INVENTION

A flow of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical plant, a gas processing plant, a cement plant, an iron or steel plant, a brewery, a bakery, a glass manufacturing facility, or similar type facilities, an exhaust gas stream generated by an internal combustion engine, or a flow of ambient air.

As is well known, carbon dioxide is a greenhouse gas that contributes to global warming/climate change.

Thus, there is a need for an efficient and effective system and method to remove carbon dioxide from a flow of gas having carbon dioxide therein.

### BRIEF SUMMARY OF THE INVENTION

In one aspect, a system for removing carbon dioxide from a flow of gas having carbon dioxide therein is featured. The system includes a first venturi eductor configured to receive the flow of gas having carbon dioxide therein and a flow of a first alkaline solution at a first predetermined pH range. The first venturi eductor is configured to introduce and mix the flow of gas having carbon dioxide therein into the flow of the first alkaline solution to induce a reaction of the carbon dioxide with the first alkaline solution to form a solution having metal bicarbonate therein. A first reactor is coupled to the first venturi eductor. The first reactor includes a volume of the first alkaline solution at the first predetermined pH and is configured to provide sufficient reaction time to augment the reaction of the carbon dioxide with the first alkaline solution to increase the concentration of metal bicarbonate in the solution having metal bicarbonate therein and output a flow of partially treated gas having carbon dioxide therein. A second venturi eductor is configured to receive the flow of the partially treated gas and a flow of a second alkaline solution at a second predetermined pH range. The second venturi eductor is configured to introduce and mix the flow of the partially treated gas into the flow of the second alkaline solution to induce a reaction of a majority of the remaining carbon dioxide with the second alkaline solution to form a solution having metal carbonate therein. A second reactor is coupled to the second venturi eductor. The second reactor includes a volume of the second alkaline solution at the second predetermined pH range and is configured to provide sufficient reaction time to augment the reaction of the majority of the remaining carbon dioxide with the second alkaline solution to increase the concentration of metal carbonate in the solution having metal carbonate therein. The second reactor is configured to output a flow of the solution having metal carbonate therein into the flow of the first alkaline solution and/or the first reactor to maintain the pH of the first alkaline solution at the first predetermined pH range and output a flow of treated gas having a majority of the carbon dioxide removed. A pH adjustment subsystem is configured to introduce a flow of a concentrated alkaline solution into the flow of the second alkaline solution and/or the second reactor to maintain the pH of the second alkaline solution at the second predetermined pH.

In one embodiment, the system includes an outlet coupled to the first reactor configured to output a flow of the solution having metal bicarbonate therein to minimize or prevent formation of metal bicarbonate precipitate in at least one of the first reactor or the flow of the first alkaline solution. The system may include at least one heat exchanger subsystem configured to cool the flow of the gas having carbon dioxide therein. The first predetermined pH range may be in the range about 8 to about 12. The second predetermined pH range may be in the range about 10 to about 15. The system may include an outlet coupled to the second reactor configured to output the flow of the solution having metal carbonate therein to minimize or prevent formation of metal carbonate precipitate in at least one of the second reactor or the flow of the second alkaline solution. The system may include a heat exchanger subsystem coupled to the first reactor configured to maintain the temperature of first alkaline solution in the first reactor at a temperature which augments the reaction of the carbon dioxide with the first alkaline solution to form the solution having metal bicarbonate therein. The pH adjustment subsystem may be configured to introduce a flow of a concentrated alkaline solution into the flow of the second alkaline solution and/or the second reactor to maintain the pH of the second alkaline solution at the second predetermined pH range. The system may include a dilution subsystem configured to introduce a flow of water into the flow of the second alkaline solution and/or the second reactor to minimize or prevent precipitation of metal carbonate in the flow of the second alkaline solution and/or in the second reactor. The system may include a dilution subsystem configured to introduce a flow of water into the flow of the first alkaline solution and/or the first reactor to minimize or prevent precipitation of metal bicarbonate in the flow of the first alkaline solution and/or in the first reactor. The pH adjustment system may minimize or prevent formation of metal carbonate precipitate by adjusting the flow rate of the concentrated alkaline solution into the flow of the second alkaline solution and/or the flow rate of the concentrated alkaline solution into the second reactor. The system may include a carbon dioxide monitoring subsystem configured to measure carbon dioxide concentration in the treated flow of gas having a majority of the carbon dioxide removed. The system includes a control subsystem coupled to the carbon dioxide monitoring subsystem, one or more pH sensors, and the pH adjustment subsystem. The control subsystem may be configured to adjust the flow rate of the concentrated alkaline solution to maintain the pH of the second alkaline solution at the second predetermined pH range based on the measured carbon dioxide concentration. The system may include an evaporator subsystem coupled to the output configured to evaporate water from the flow of the solution having metal bicarbonate therein and output a mixture having metal bicarbonate slurry or solid therein and water vapor. Waste heat may be input to the evaporator subsystem to promote the evaporation of water from the flow of solution having metal bicarbonate therein.

In another aspect, a method for removing carbon dioxide from a flow of gas having carbon dioxide therein is featured. The method includes receiving the flow of gas having carbon dioxide therein and a flow of a first alkaline solution at a first predetermined pH range, introducing and mixing the flow of gas having carbon dioxide therein into the flow of the first alkaline solution to induce a reaction of carbon dioxide with the first alkaline solution to form a solution having metal bicarbonate therein, providing a volume of the first alkaline solution at the first predetermined pH and sufficient reaction time to augment the reaction of the carbon dioxide with the first alkaline solution to increase the concentration of metal bicarbonate in the solution having metal bicarbonate therein and output a flow of partially treated gas having carbon dioxide therein. The method may include receiving the flow of the partially treated gas and a flow of a second alkaline solution at a second predetermined pH range, introducing and mixing the flow of the partially treated gas into the flow of the second alkaline solution to induce a reaction of a majority of the remaining carbon dioxide with the second alkaline solution to form a solution having metal carbonate therein, providing a volume of the second alkaline solution at the second predetermined pH range to provide sufficient reaction time to augment the reaction of the majority of the remaining carbon dioxide with the second alkaline solution to increase the concentration of metal carbonate in the solution having metal carbonate therein, and outputting a flow of the solution having metal carbonate therein into the flow of the first alkaline solution and/or the volume of the first alkaline solution to maintain the pH of the first alkaline solution at the first predetermined pH range and output a flow of treated gas having a majority of the carbon dioxide removed. The method also includes introducing a flow of a concentrated of alkaline solution into the flow of the second alkaline solution and/or the volume of the second alkaline solution to maintain the pH of the second alkaline solution at the second predetermined pH.

In one embodiment, the method may include outputting a flow of the solution having metal bicarbonate therein to minimize or prevent formation of metal bicarbonate precipitate in at least one first reactor or the flow of the first alkaline solution. The method may cooling the flow of the gas having carbon dioxide therein. The first predetermined pH range may be in the range about 8 to about 12. The second predetermined pH range may be in the range about 10 to about 15. The method may include outputting the flow of the solution having metal carbonate therein to minimize or prevent formation of metal carbonate precipitate in at least one second reactor or the flow of the second alkaline solution. The method may include maintaining the temperature of first alkaline solution in a first reactor at a temperature which augments the reaction of the carbon dioxide with the first alkaline solution to form the solution having metal bicarbonate therein. The method may include introducing a flow of a concentrated alkaline solution into the flow of the second alkaline solution to maintain the pH of the second alkaline solution at the second predetermined pH range. The method may include introducing a flow of water into the flow of the second alkaline solution and/or a second reactor to minimize or prevent precipitation of metal carbonate in the flow of the second alkaline solution and/or in the second reactor. The method may include introducing a flow of water into the flow of the first alkaline solution and/or a first reactor to minimize or prevent precipitation of metal bicarbonate in the flow of the first alkaline solution and/or in the first reactor. The method may include minimizing or preventing formation of metal carbonate precipitate by adjusting the flow rate of the concentrated alkaline solution into the flow of the second alkaline solution and/or the flow rate of the concentrated alkaline solution into the second reactor. The method may include measuring carbon dioxide concentration in the treated flow of gas having a majority of the carbon dioxide removed. The method may include adjusting the flow rate of the concentrated alkaline solution to maintain the pH of the second alkaline solution at the second predetermined pH range based on the measured carbon dioxide concentration. The method may include evaporating water from the flow of the solution having metal bicarbonate therein and outputting a mixture having metal bicarbonate slurry or solid therein and water vapor. Waste heat may be used to promote the evaporation of water from the flow of solution having metal bicarbonate therein.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIGS. 1A and 1B are schematic block diagrams showing the primary components of one example of system for removing carbon dioxide from a flow of gas having carbon dioxide therein;

FIGS. 2A and 2B are schematic block diagrams showing the primary components of another example of system for removing carbon dioxide from a flow of gas having carbon dioxide therein; and

FIGS. 3A and 3B depict a flow chart showing the primary steps of one example of the method for removing carbon dioxide from a flow of gas having carbon dioxide therein.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

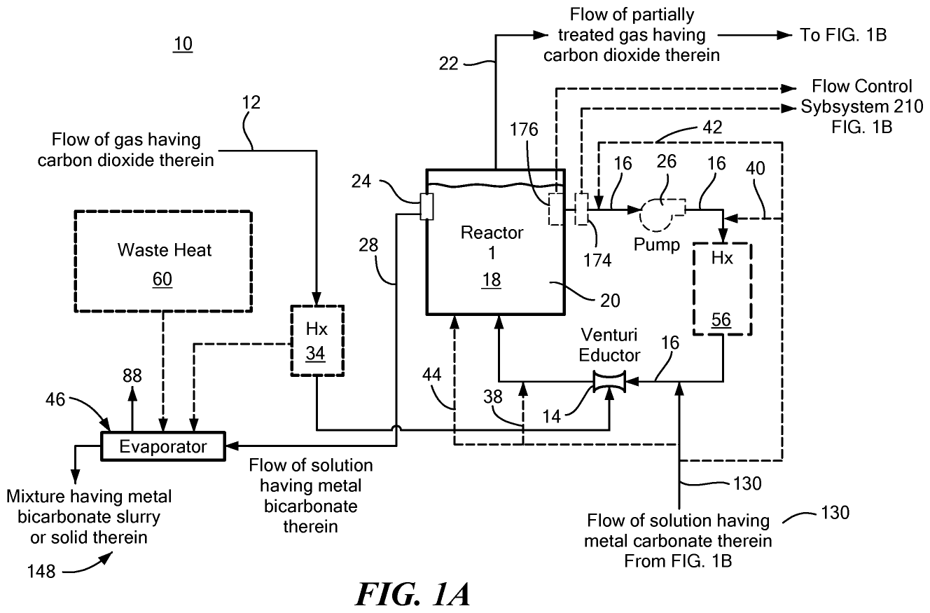

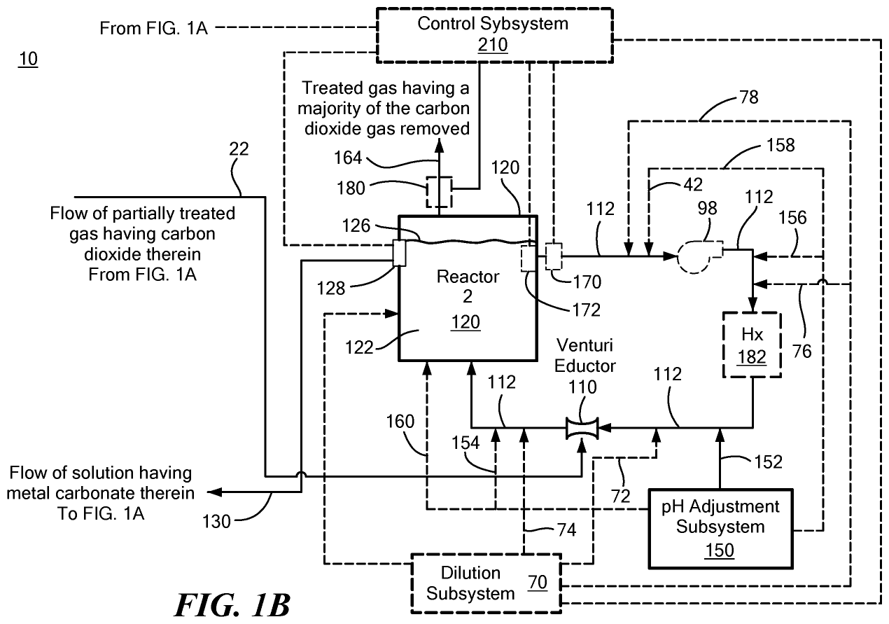

There is shown in FIG. 1, one example of system 10 for removing carbon dioxide from flow 12 of gas having carbon dioxide therein. Flow 12 of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical plant, a gas processing plant, a cement plant, an iron or steel plant, a brewery, a bakery, a glass manufacturing facility, or devices or similar type facilities, an exhaust gas stream generated by an internal combustion engine, or a flow of ambient air.

In some examples, flow 12 may be hot, e.g., about 700° F. and needs to be cooled to about 70° F. or about 100° F. prior to entering a CO₂ removal reactor, as discussed below. To address this, system 10 may include at least one heat exchanger subsystem 34 which receives flow 12 and cools it as needed.

System 10 includes first venturi eductor 14 which receives flow 12 of gas having carbon dioxide therein and flow 16 of a first alkaline solution at a first predetermined pH range. In one example, the first predetermined pH range of the first alkaline solution is preferably in the range of about 8 to about 12. The first alkaline solution at the first predetermined pH range preferably includes a liquid, such as water, deionized water, or similar type liquid and an alkali, such as sodium hydroxide, potassium hydroxide, magnesium hydroxide, or similar type alkali.

First venturi eductor 14 introduces and mixes flow 12 of gas having carbon dioxide therein into flow 16 of the first alkaline solution to induce a reaction of the carbon dioxide with the first alkaline solution to form a solution having metal bicarbonate (HCO₃⁻¹) therein. As is known to those skilled in the art, the solution having metal bicarbonate therein may include trace amounts of metal carbonate (CO₃⁻²) and/or other chemical constituents.

System 10 also includes first reactor 18, also referred herein as a carbon dioxide removal reactor or a carbon dioxide absorber, coupled to first venturi eductor 14 preferably as shown. First reactor 18 includes a volume of the first alkaline solution at the first predetermined pH range, indicated at 20. First reactor 18 with the first alkaline solution therein provides sufficient reaction time to augment the reaction of the carbon dioxide with the first alkaline solution to increase the concentration of metal bicarbonate in the solution having metal bicarbonate therein. First reactor 18 outputs flow 22 of partially treated gas having carbon dioxide therein. As disclosed herein, flow 22 of partially treated gas having carbon dioxide therein has at least 50% of the carbon dioxide removed.

The solution having metal bicarbonate therein may include, inter alia, sodium bicarbonate (NaHCO₃), potassium bicarbonate (KHCO₃), magnesium bicarbonate (Mg(HCO₃)₂, or similar type metal bicarbonate.

System 10 may include at least one first pump 26 coupled to first reactor 18 as shown. Pump 26 preferably recycles the first alkaline solution in first reactor 18 having metal bicarbonate and any unreacted carbon dioxide therein from first reactor 18 back to first venturi eductor 14 as shown by flow 16. Flow 16 is pumped at a sufficient rate so that first venturi eductor 14 can effectively introduce and mix flow 12 with flow 16 to induce the reaction of the carbon dioxide with the first alkaline solution to form the solution having metal bicarbonate therein.

System 10 also includes second venturi eductor 110, FIG. 1B, which receives flow 22 of the partially treated gas and flow 112 of a second alkaline solution at a second predetermined pH range as shown. In this example, the second predetermined pH range is preferably in the range of about 10 to about 15. In one example, the second alkaline solution at the second predetermined pH range preferably includes a liquid, such as water, deionized water, or similar type liquid and a metal hydroxide, such as sodium hydroxide, potassium hydroxide, magnesium hydroxide, or similar type metal hydroxide.

Second venturi eductor 110 introduces and mixes flow 22 of the partially treated gas having carbon dioxide therein into flow 112 of the second alkaline solution to induce a reaction of a majority of the remaining carbon dioxide with the second alkaline solution to form a solution having metal carbonate therein.

System 10 also includes second reactor 120 coupled second venturi eductor 110 preferably as shown. Second reactor 120 preferably includes a volume of the second alkaline solution at the second predetermined pH range, indicated at 122. Second reactor 120 provides sufficient reaction time to augment the reaction of the majority of the remaining carbon dioxide in flow 22 with second alkaline solution to increase the concentration of metal carbonate in the solution having metal carbonate therein.

The solution of metal carbonate may include, inter alia, sodium carbonate (Na₂CO₃), potassium carbonate (K₂CO₃), magnesium carbonate (MgCO₃) or similar type metal carbonate.

In one design, system 10 may include at least one second pump 98 coupled to second reactor 120 as shown. Second pump 98 preferably recycles the second alkaline solution in second reactor 120 having metal carbonate therein and any unreacted carbon dioxide therein from second reactor 120 back to second venturi eductor 110, as shown by flow 112. Flow 112 is pumped at a sufficient rate so that second venturi eductor 110 can effectively introduce and mix flow 112 with flow 22 to induce the reaction of the carbon dioxide with the first alkaline solution to form the solution having metal carbonate therein.

Second reactor 120 preferably outputs flow 130 of solution having metal carbonate therein into flow 16, FIG. 1A, of the first alkaline solution and/or first reactor 18 which preferably maintains the pH of the first alkaline solution at the first predetermined pH range.

Flow 130 of the metal carbonate solution may be introduced into flow 12, FIG. 1A, upstream from venturi eductor 14 as shown, downstream from first venturi eductor 14, indicated at 38, downstream or upstream from pump 26, indicated at 40, 42, respectively, and/or directly into first reactor 18, indicated at 44, to maintain the pH of the first alkaline solution at the first predetermined pH range.

Second reactor 120, FIG. 1B, also outputs flow 164 of treated gas having a majority of the carbon dioxide removed. As disclosed herein flow 164 of treated gas having a majority of the carbon dioxide removed preferably has a least about 90% of the carbon dioxide removed from flow 12, FIG. 1A, of gas having carbon dioxide therein.

System 10 also includes pH adjustment subsystem 150, FIG. 1B, which preferably maintains the pH of the second alkaline solution at the second predetermined pH. In one example, pH subsystem 150 preferably introduces flow 152 of concentrated of alkaline solution into flow 112 of the second alkaline solution and/or second reactor 120 to maintain the pH of the second alkaline solution at the second predetermined pH range. Flow 152 of concentrated alkaline solution may include sodium hydroxide (NaOH), potassium hydroxide (KOH), magnesium hydroxide Mg(OH)₂, calcium hydroxide Ca(OH)₂, or similar type alkali. In one example, the concentration of flow 152 of concentrated alkaline solution is about 1% to about 50%.

In one design, flow 152 of concentrated alkaline solution may be introduced into flow 112 upstream from venturi eductor 110 as shown. In other examples, flow 152 of may be introduced to flow 112 downstream from venturi eductor 110, indicated at 154, downstream or upstream from pump 98, indicated at 156, 158, respectfully, and/or directly to second reactor 120, indicated at 160.

As discussed above, second reactor 120 preferably outputs flow 130 of solution having metal carbonate therein into flow 16, FIG. 1A, of the first alkaline solution and/or first reactor 18 to maintain the pH of the first alkaline solution at the first predetermined pH range. pH adjustment subsystem 150, FIG. 1B, is preferably configured such that changes made to the pH of the second alkaline solution will affect the pH of flow 130 of solution having metal carbonate therein and subsequently adjust the pH of flow 16, FIG. 1A, of the first alkaline solution and/or the pH of the first alkaline solution in first reactor 18.

System 10 preferably includes outlet 24 coupled to first reactor 18 which outputs flow 28 of the first solution having metal bicarbonate therein to minimize or prevent formation of metal bicarbonate precipitate in at least one of first reactor 18 or the flow 16 of the first alkaline solution.

As is well known in the art, the formation of a metal bicarbonate precipitate in reactor 18 may significantly decrease the performance of reactor 18 by forming precipitate on the walls of reactor 18 and the various components of system 10 including, inter alia, venturi eductor 14 and/or pump 24.

Similarly, system 10 preferably includes outlet 128, FIG. 1B, coupled to second reactor 120 which outputs flow 130 of the solution having metal the carbonate therein at a flow rate which preferably minimizes or prevents the formation of metal carbonate precipitate in at least one of reactor 120 or flow 112 of the second alkaline solution.

Similarly, the formation of a metal carbonate precipitate in reactor 120 may significantly decrease the performance of reactor 120 by forming precipitate on the walls of reactor 120 and the various components of system 10 including, inter alia, venturi eductor 110 and/or pump 98.

In one design, system 10 preferably includes dilution subsystem 70, FIG. 1B, which preferably introduces flow 72 of water into flow 112 of the second alkaline solution and/or second reactor 120 to minimize or prevent precipitation of metal carbonate in the flow 112 of second alkaline solution and/or the second alkaline solution in second reactor 120.

In example, flow 72 of water may be introduced into flow 112 upstream from venturi eductor 110 as shown. In other examples, flow 72 of may be introduced to flow 112 downstream from venturi eductor, indicated at 74, downstream or upstream from pump 98, indicated at 76, 78, respectfully, and/or directly to reactor 120, indicated at 80.

Dilution subsystem 70 may similarly introduce flow 72 of water into flow 16 of the first alkaline solution and/or first reactor 18 to minimize or prevent precipitation of metal bicarbonate in flow 16 of first alkaline solution and/or the first alkaline solution in first reactor 18.

In one design, pH adjustment system 150 preferably minimizes or prevents formation of the metal carbonate precipitate in flow 112 and/or reactor 120 by adjusting the flow rate of flow 152 of concentrated alkaline solution into flow 112 of the second alkaline solution and/or second reactor 120.

System 10 may also include carbon dioxide monitoring subsystem 180 which preferably monitors the carbon dioxide concentration of flow 164 of treated gas having a majority of the carbon dioxide removed.

System 10 preferably includes one or more pH sensors which preferably measure the pH in flow 112, FIG. 1B, of the second alkaline solution and/or the pH of the second alkaline solution in second reactor 120, the pH of flow 16, FIG. 1A, of the first alkaline solution and/or the pH of the first alkaline solution in first reactor 18. In this example, system 10 includes pH sensor 170, FIG. 1B, located upstream from pump 98, pH sensor 172 located in second reactor 120, pH sensor 174, FIG. 1A located upstream from pump 26, and pH sensor 176 in reactor 18 as shown. In other examples, the pH sensors may be located in any desired location of system 10.

System 10 preferably includes control subsystem 210, FIG. 1B, e.g., a programmable logic controller (PLC) or similar type device, preferably coupled to carbon dioxide monitoring subsystem 180, pH adjustment subsystem 150, and one or more pH sensors, e.g., pH sensors 170, 172, 174, and 176 as shown. Control subsystem 210 preferably adjusts the flow rate of flow 152 of concentrated alkaline solution into flow 112 and/or reactor 120 based on the measured carbon dioxide concentration to maintain the pH of the second alkaline solution at the second predetermined pH range to induce the reaction of a majority of the remaining carbon dioxide with the second alkaline solution to form the solution having metal carbonate therein, as discussed above.

System 10 preferably includes evaporator subsystem 46, FIG. 1A, preferably coupled to output 24 as shown which evaporates liquid, e.g., water or a similar type of liquid, from flow 26 of solution having metal bicarbonate therein. Evaporator subsystem 46 preferably outputs mixture 48 having metal bicarbonate slurry or solid therein and flow 88 of a gas, e.g., water vapor. Mixture 48 having metal bicarbonate slurry or solid therein may be useful in organic synthesis, pharmaceuticals, analytic chemistry, biotechnology, animal feed, toothpaste, household cleaners and detergents, antacids, and the like.

In one example, first venturi eductor 14, FIG. 1A, preferably generates microbubbles and turbulence in flow 16 and/or reactor 18 which induces the reaction of the carbon dioxide with the first alkaline solution to form the solution having metal bicarbonate therein. Similarly, second venturi eductor 110, FIG. 1B, may generate microbubbles and turbulence in flow 112 and/or reactor 120 which induces the reaction of a majority of the remaining carbon dioxide with the second alkaline solution to form the solution having metal carbonate therein. Microbubbles have substantial surface area (per unit volume) for the transfer (flux) of CO₂ across the liquid film, e.g., the gas-liquid interface. Microbubbles provide a faster flux of CO₂ from the gas bubbles into the first alkaline solution in reactor 18 and/or flow 16 and the second alkaline solution in reactor 120 and/or flow 112. Turbulence/agitation/mixing reduces the thickness of the laminar liquid layer where molecular diffusion predominates. Molecular diffusion happens much more slowly than dispersion. Dispersion is induced by turbulence. Therefore, turbulence speeds up the flux of gas-phase CO₂ across the gas-liquid interface. The concentration gradient across the gas-liquid interface is also known as the driving force. The larger the concentration gradient, i.e., the difference between CO₂ concentrations on either side of the interface, the faster the transfer of CO₂ into the liquid.

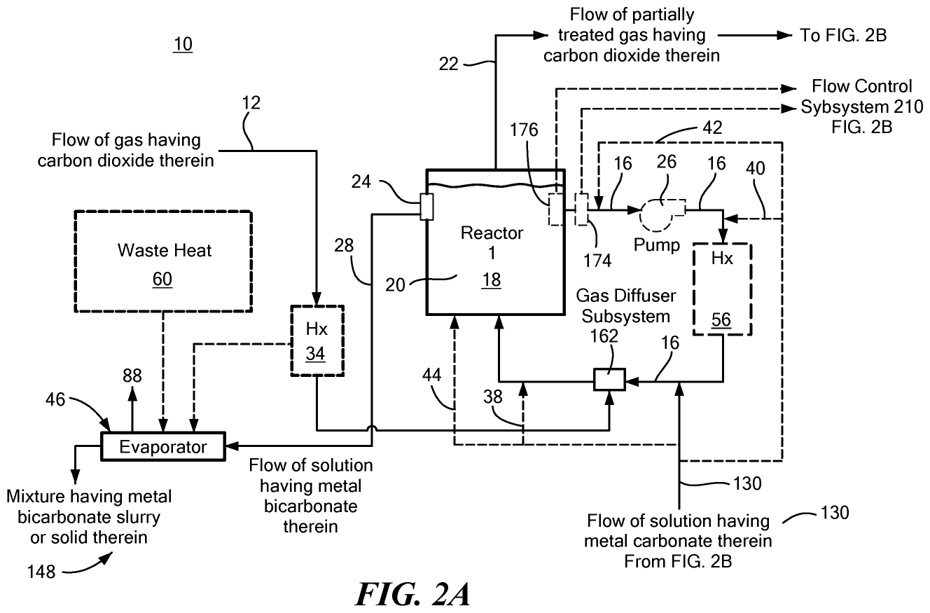

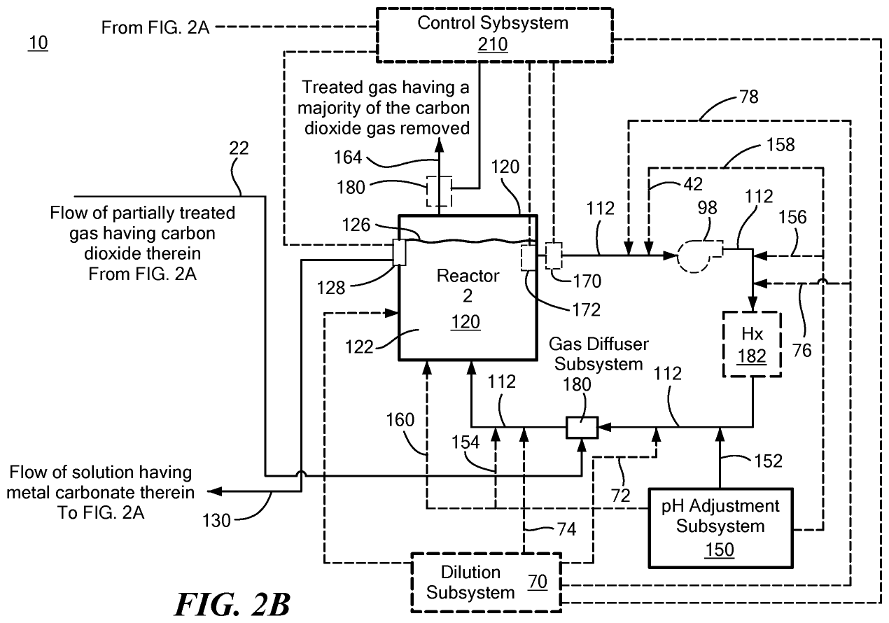

In another design, system 10 may include gas diffuser subsystem 162, FIG. 2A, where like parts have been given like numbers, instead of venture eductor 14, which preferably generates fine bubbles, microbubbles, or nanobubbles in flow 16 and/or reactor 18 to induce a reaction the carbon dioxide with the first alkaline solution to form the solution having metal bicarbonate therein. In one design, gas diffuser subsystem 162 may be located outside of reactor 18 as shown. In other designs, gas diffuser subsystem 162 may be located inside reactor 18 as known by those skilled in art.

In another design, system 10 may include gas diffuser subsystem 180, FIG. 2B, where like parts have been given like numbers, instead of venturi eductor 110, which preferably generates fine bubbles, microbubbles, or nanobubbles in flow 112 and/or reactor 120 to enhance the reaction of a majority of the remaining carbon dioxide with the second alkaline solution to form the solution having metal carbonate therein. In one design, gas diffuser subsystem 180 may be located outside of reactor 120 as shown. In other designs, gas diffuser subsystem 180 may be located inside reactor 120 as known by those skilled in art.

System 10 may also include heat exchanger subsystem 182, FIGS. 1B and 2B, coupled to pump 98 which cools flow 112 to maintain the temperature of the second alkaline solution in reactor 120 at a temperature which augments the reaction of a majority of the remaining carbon dioxide with the second alkaline solution to form the solution having metal carbonate therein.

In one example, pump 98, FIGS. 1B and 2B, may be operated in cavitation to promote the reaction of any unreacted carbon dioxide in flow 112 output from reactor 120 with the second alkaline solution to form the solution having metal carbonate therein.

System 10 may also include heat exchanger subsystem 56, FIGS. 1A and 2A, which may be coupled to pump 26, which cools flow 16 to maintain the temperature of the first alkaline solution in reactor 18 at a temperature which augments the reaction of the carbon dioxide with the first alkaline solution to form the solution having metal bicarbonate therein.

In one example, pump 26 may be operated in cavitation to promote the reaction of any unreacted carbon dioxide in flow 16 output from reactor 18 with the first alkaline solution to form the solution having metal bicarbonate therein.

In one example, waste heat 60, FIG. 1A, e.g., waste heat from at least one of a heat exchanger, an internal combustion engine, a fossil fuel combustion power plant, a boiler, a furnace, an incinerator, a steam generator, a petroleum refinery, a chemical or petrochemical plant, a gas processing plant, a cement plant, an iron or steel plant, a brewery, a bakery, a glass manufacturing facility, or similar type facility, may be input to evaporator subsystem 46 as shown to promote the evaporation of liquid from flow 26 of solution having metal bicarbonate therein by evaporator subsystem 46. System 10 may also utilize waste heat or steam from heat exchanger subsystem 34 as shown which is preferably input to evaporator subsystem 46 to promote the evaporation of liquid from flow 26 of the metal bicarbonate solution.

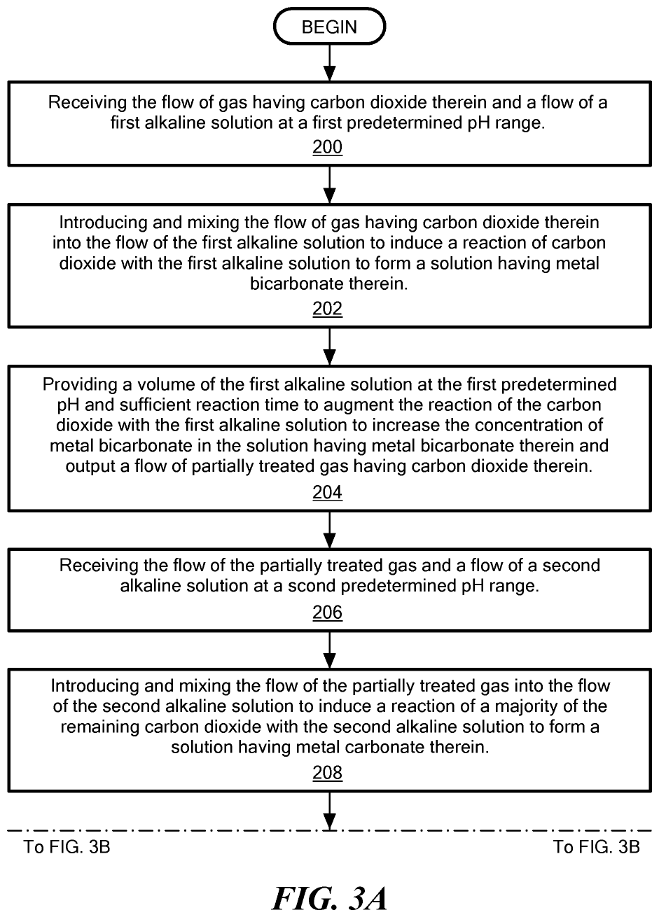

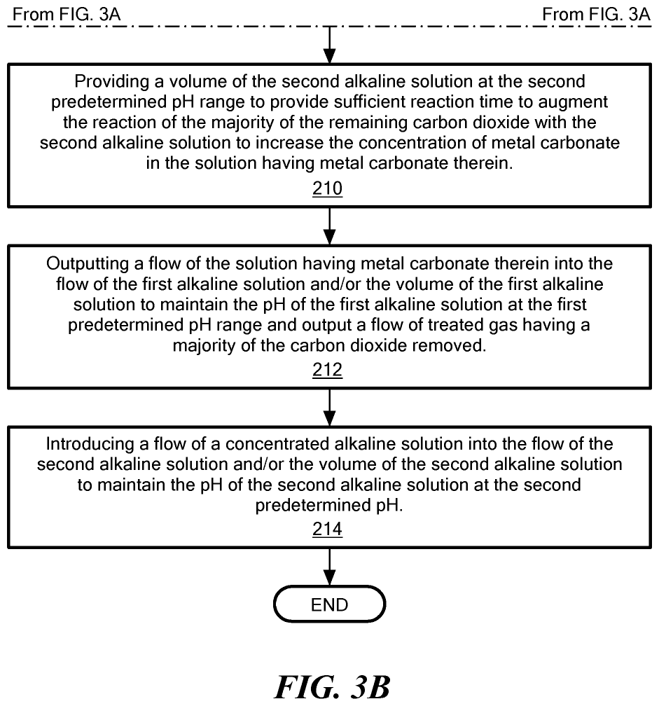

One example of the method for removing carbon dioxide from a flow of gas having carbon dioxide therein includes receiving the flow of gas having carbon dioxide therein and a flow of a first alkaline solution at a first predetermined pH range, step 200, FIG. 3A, introducing and mixing the flow of gas having carbon dioxide therein into the flow of the first alkaline solution to induce a reaction of carbon dioxide with the first alkaline solution to form a solution having metal bicarbonate therein, step 202, and providing a volume of the first alkaline solution at the first predetermined pH and sufficient reaction time to augment the reaction of the carbon dioxide with the first alkaline solution to increase the concentration of metal bicarbonate in the solution having metal bicarbonate therein and output a flow of partially treated gas having carbon dioxide therein, step 204. The method also includes receiving the flow of the partially treated gas and a flow of a second alkaline solution at a second predetermined pH range, step 206, introducing and mixing the flow of the partially treated gas into the flow of the second alkaline solution to induce a reaction of a majority of the remaining carbon dioxide with the second alkaline solution to form a solution having metal carbonate therein, step 208, and providing a volume of the second alkaline solution at the second predetermined pH range to provide sufficient reaction time to augment the reaction of the majority of the remaining carbon dioxide with the second alkaline solution to increase the concentration of metal carbonate in the solution having metal carbonate therein, step 210, FIG. 3B. The method also includes outputting a flow of the solution having metal carbonate therein into the flow of the first alkaline solution and/or the volume of the first alkaline solution to maintain the pH of the first alkaline solution at the first predetermined pH range and output a flow of treated gas having a majority of the carbon dioxide removed, step 212, and introducing a flow of a concentrated alkaline solution into the flow of the second alkaline solution and/or the volume of the second alkaline solution to maintain the pH of the second alkaline solution at the second predetermined pH, step 214.

The result is system 10 and the method thereof effectively and efficiently removes carbon dioxide from a flow of gas having carbon dioxide. The flow of gas having carbon dioxide therein may include any gas or vapor source having carbon dioxide therein. The gas or vapor source may include, inter alia, a fossil fuel combustion power plant, a boiler, a furnace, an incinerator, a steam generator, a petroleum refinery, a chemical or petrochemical plant, a gas processing plant, cement plant, iron and steel plants, a brewery, a bakery, a glass manufacturing facility, or similar type facility, an internal combustion engine, or a flow of ambient air. Because system 10 and the method thereof outputs a flow of metal carbonate from the second reactor to the first reactor to maintain the pH of the first alkaline solution at the first predetermined pH range, system 10 and the method thereof uses approximately one-half of the concentrated alkaline solution provided by the pH adjustment subsystem when compared to a single reactor system. Thus, system 10 and the method thereof may significantly reduce the cost to remove carbon dioxide from a flow of gas having carbon dioxide therein. System 10 and the method thereof also utilizes waste heat to provide for the evaporation of water from the flow of solution having metal bicarbonate therein. System 10 and the method thereof may also produce a mixture having metal bicarbonate slurry or solid therein which may be useful in organic synthesis, pharmaceuticals, analytic chemistry, biotechnology, animal feed, toothpaste, household cleaners and detergents, antacids, and the like.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A system for removing carbon dioxide from a flow of gas having carbon dioxide therein, the system comprising:
a first venturi eductor configured to receive the flow of gas having carbon dioxide therein and a flow of a first alkaline solution at a first predetermined pH range, the first venturi eductor configured to introduce and mix the flow of gas having carbon dioxide therein into the flow of the first alkaline solution to induce a reaction of the carbon dioxide with the first alkaline solution to form a solution having metal bicarbonate therein;
a first reactor coupled to the first venturi eductor, the first reactor including a volume of the first alkaline solution at the first predetermined pH and configured to provide sufficient reaction time to augment the reaction of the carbon dioxide with the first alkaline solution to increase the concentration of metal bicarbonate in the solution having metal bicarbonate therein and output a flow of partially treated gas having carbon dioxide therein;
a second venturi eductor configured to receive the flow of the partially treated gas and a flow of a second alkaline solution at a second predetermined pH range, the second venturi eductor configured to introduce and mix the flow of the partially treated gas into the flow of the second alkaline solution to induce a reaction of a majority of the remaining carbon dioxide with the second alkaline solution to form a solution having metal carbonate therein;
a second reactor coupled to the second venturi eductor, the second reactor including a volume of the second alkaline solution at the second predetermined pH range and configured to provide sufficient reaction time to augment the reaction of the majority of the remaining carbon dioxide with the second alkaline solution to increase the concentration of metal carbonate in the solution having metal carbonate therein;
the second reactor configured to output a flow of the solution having metal carbonate therein into the flow of the first alkaline solution and/or the first reactor to maintain the pH of the first alkaline solution at the first predetermined pH range and output a flow of treated gas having a majority of the carbon dioxide removed; and
a pH adjustment subsystem configured to introduce a flow of a concentrated alkaline solution into the flow of the second alkaline solution and/or the second reactor to maintain the pH of the second alkaline solution at the second predetermined pH.

2. The system of claim 1 including an outlet coupled to the first reactor configured to output a flow of the solution having metal bicarbonate therein to minimize or prevent formation of metal bicarbonate precipitate in at least one of the first reactor or the flow of the first alkaline solution.

3. The system of claim 1 including at least one heat exchanger subsystem configured to cool the flow of the gas having carbon dioxide therein.

4. The system of claim 1 in which the first predetermined pH range is in the range about 8 to about 12.

5. The system of claim 1 in which the second predetermined pH range is in the range about 10 to about 15.

6. The system of claim 1 including an outlet coupled to the second reactor configured to output the flow of the solution having metal carbonate therein to minimize or prevent formation of metal carbonate precipitate in at least one of the second reactor or the flow of the second alkaline solution.

7. The system of claim 1 including a heat exchanger subsystem coupled to the first reactor configured to maintain the temperature of first alkaline solution in the first reactor at a temperature which augments the reaction of the carbon dioxide with the first alkaline solution to form the solution having metal bicarbonate therein.

8. The system of claim 1 in which the pH adjustment subsystem is configured to introduce a flow of a concentrated alkaline solution into the flow of the second alkaline solution and/or the second reactor to maintain the pH of the second alkaline solution at the second predetermined pH range.

9. The system of claim 1 including a dilution subsystem configured to introduce a flow of water into the flow of the second alkaline solution and/or the second reactor to minimize or prevent precipitation of metal carbonate in the flow of the second alkaline solution and/or in the second reactor.

10. The system of claim 1 including a dilution subsystem configured to introduce a flow of water into the flow of the first alkaline solution and/or the first reactor to minimize or prevent precipitation of metal bicarbonate in the flow of the first alkaline solution and/or in the first reactor.

11. The system of claim 8 in which the pH adjustment system is configured to minimize or prevent formation of metal carbonate precipitate by adjusting the flow rate of the concentrated alkaline solution into the flow of the second alkaline solution and/or the flow rate of the concentrated alkaline solution into the second reactor.

12. The system of claim 1 including a carbon dioxide monitoring subsystem configured to measure carbon dioxide concentration in the treated flow of gas having a majority of the carbon dioxide removed.

13. The system of claim 12 including a control subsystem coupled to the carbon dioxide monitoring subsystem, one or more pH sensors, and the pH adjustment subsystem, the control subsystem configured to adjust the flow rate of the concentrated alkaline solution to maintain the pH of the second alkaline solution at the second predetermined pH range based on the measured carbon dioxide concentration.

14. The system of claim 1 including an evaporator subsystem coupled to the output configured to evaporate water from the flow of the solution having metal bicarbonate therein and output a mixture having metal bicarbonate slurry or solid therein and water vapor.

15. The system of claim 14 in which waste heat is input to the evaporator subsystem to promote the evaporation of water from the flow of solution having metal bicarbonate therein.

16. A method for removing carbon dioxide from a flow of gas having carbon dioxide therein, the method comprising:
receiving the flow of gas having carbon dioxide therein and a flow of a first alkaline solution at a first predetermined pH range;
introducing and mixing the flow of gas having carbon dioxide therein into the flow of the first alkaline solution to induce a reaction of carbon dioxide with the first alkaline solution to form a solution having metal bicarbonate therein;
providing a volume of the first alkaline solution at the first predetermined pH and sufficient reaction time to augment the reaction of the carbon dioxide with the first alkaline solution to increase the concentration of metal bicarbonate in the solution having metal bicarbonate therein and output a flow of partially treated gas having carbon dioxide therein;
receiving the flow of the partially treated gas and a flow of a second alkaline solution at a second predetermined pH range;
introducing and mixing the flow of the partially treated gas into the flow of the second alkaline solution to induce a reaction of a majority of the remaining carbon dioxide with the second alkaline solution to form a solution having metal carbonate therein;
providing a volume of the second alkaline solution at the second predetermined pH range to provide sufficient reaction time to augment the reaction of the majority of the remaining carbon dioxide with the second alkaline solution to increase the concentration of metal carbonate in the solution having metal carbonate therein;
outputting a flow of the solution having metal carbonate therein into the flow of the first alkaline solution and/or the volume of the first alkaline solution to maintain the pH of the first alkaline solution at the first predetermined pH range and output a flow of treated gas having a majority of the carbon dioxide removed; and
introducing a flow of a concentrated alkaline solution into the flow of the second alkaline solution and/or the volume of the second alkaline solution to maintain the pH of the second alkaline solution at the second predetermined pH.

17. The method of claim 16 including outputting a flow of the solution having metal bicarbonate therein to minimize or prevent formation of metal bicarbonate precipitate in at least one first reactor or the flow of the first alkaline solution.

18. The method of claim 16 including cooling the flow of the gas having carbon dioxide therein.

19. The method of claim 16 in which the first predetermined pH range is in the range about 8 to about 12.

20. The method of claim 16 in which the second predetermined pH range is in the range about 10 to about 15.

21. The method of claim 16 including outputting the flow of the solution having metal carbonate therein to minimize or prevent formation of metal carbonate precipitate in at least one second reactor or the flow of the second alkaline solution.

22. The method of claim 16 including maintaining the temperature of first alkaline solution in a first reactor at a temperature which augments the reaction of the carbon dioxide with the first alkaline solution to form the solution having metal bicarbonate therein.

23. The method of claim 16 including introducing a flow of a concentrated alkaline solution into the flow of the second alkaline solution to maintain the pH of the second alkaline solution at the second predetermined pH range.

24. The method of claim 16 including introducing a flow of water into the flow of the second alkaline solution and/or a second reactor to minimize or prevent precipitation of metal carbonate in the flow of the second alkaline solution and/or in the second reactor.

25. The method of claim 16 including introducing a flow of water into the flow of the first alkaline solution and/or a first reactor to minimize or prevent precipitation of metal bicarbonate in the flow of the first alkaline solution and/or in the first reactor.

26. The system of claim 25 including minimizing or preventing formation of metal carbonate precipitate by adjusting the flow rate of the concentrated alkaline solution into the flow of the second alkaline solution and/or the flow rate of the concentrated alkaline solution into the second reactor.

27. The method of claim 16 including measuring carbon dioxide concentration in the treated flow of gas having a majority of the carbon dioxide removed.

28. The method of claim 26 including adjusting the flow rate of the concentrated alkaline solution to maintain the pH of the second alkaline solution at the second predetermined pH range based on the measured carbon dioxide concentration.

29. The method of claim 16 including evaporating water from the flow of the solution having metal bicarbonate therein and outputting a mixture having metal bicarbonate slurry or solid therein and water vapor.

30. The method of claim 29 in which waste heat is used to promote the evaporation of water from the flow of solution having metal bicarbonate therein.
